(19) United States
(12) Patent Application Publication
(10) Pub. No.: US 2014/0339751 A1
(43) Pub. Date: Nov. 20, 2014

(54) FIXTURE FOR CLAMPING WORKPIECE

(71) Applicant: Asti Global Optoelectronics (Suzhou) LTD, Suzhou City (CN)

(72) Inventors: Chien-Chung CHEN, Suzhou City (CN); Chih-Wei HUANG, Suzhou City (CN); Chen-Yu JIANG, Suzhou City (CN); Cheng-Kang WU, Suzhou City (CN)

(73) Assignee: Asti Global Optoelectronics (Suzhou) LTD, Suzhou City (CN)

(21) Appl. No.: 13/894,128

(22) Filed: May 14, 2013

(51) Int. Cl. B25B 5/06; B25B 5/14

(52) U.S. Cl. CPC B25B 5/061; B25B 5/14
USPC 269/32

(57) ABSTRACT

A fixture for clamping a workpiece is disclosed. The fixture includes a supporting stand and an elastic contacting assembly. The supporting stand has a first accommodating space and a plural of fixing portions. The elastic contacting assembly is disposed in a corner of the supporting stand. The elastic contacting assembly includes a cylinder, a pushing block driven by the cylinder and moved toward the first accommodating space to lean against the workpiece, and an elastic component disposed between the cylinder and the pushing block. Thereby, an elastic pushing force will be provided to the workpiece for positioning the workpiece, and there will be no damages to the workpiece.

### BACKGROUND OF THE INVENTION

1. Field of the Invention

The present invention generally relates to a fixture and, in particular to a fixture for clamping a workpiece.

2. Description of Related Art

In the process of manufacturing products, a fixture is often used as an auxiliary tool for ease of processing. In the processing, using a fixture can provide proper positioning and help to maintain the machining accuracy of the workpiece. Moreover, the working hours will be reduced and the productivity will be increased by using fixtures properly.

However, a brattle or thin workpiece is often damaged due to a clamping force of the fixture.

In view of the above drawbacks, the Inventor proposes the present invention based on his expert knowledge and elaborate researches in order to solve the problems of related art.

### SUMMARY OF THE INVENTION

Accordingly, an object of the present invention is to provide a fixture for clamping a workpiece. An elastic resistance is provided from an elastic contacting assembly for positioning the workpiece, and there will be no damage to the workpiece.

In order to achieve the object mentioned above, the present invention provides a fixture for clamping a workpiece. The fixture includes a supporting stand and an elastic contacting assembly. The supporting stand has a first accommodating space for accommodating the workpiece and a plural of fixing portions formed in a periphery of the first accommodating space. The elastic contacting assembly is disposed in a corner of the supporting stand. The elastic contacting assembly includes a cylinder, a pushing block driven by the cylinder and moved toward the first accommodating space for leaning against the workpiece and an elastic component disposed between the cylinder and the pushing block.

Another object of the present invention is to provide a fixture for clamping a workpiece. The supporting stand has accommodating spaces arranged in stack. Therefore, when the bottom of the workpiece is not formed in a plane, it still can be disposed and positioned in the accommodating space.

Comparing to the related art, the fixture for clamping a workpiece of the present invention has provided an elastic contacting assembly on a side of the supporting stand. The elastic contacting assembly includes a cylinder, a pushing block and an elastic component. This device can make the pushing block elastically push the workpiece, wherein one side of the workpiece leans against the pushing block, and another side leans against the fixing portions. Thereby, an elastic pushing force will be provided to the workpiece for positioning, and there will be no damages to the workpiece.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective schematic view of a fixture according to the present invention;

FIG. 2 is a planar view of a fixture according to the present invention;

FIG. 3 is a perspective view showing the application of a fixture according to the present invention;

FIG. 4 is a planar schematic view showing the application of a fixture according to the present invention;

FIG. 5 is a schematic view showing operation of a fixture according to the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

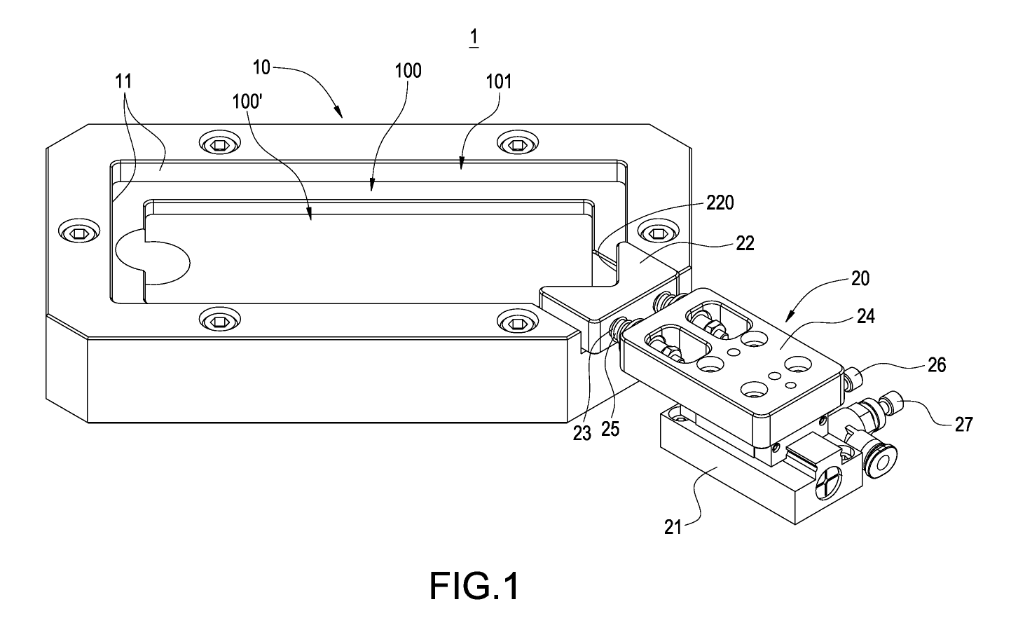

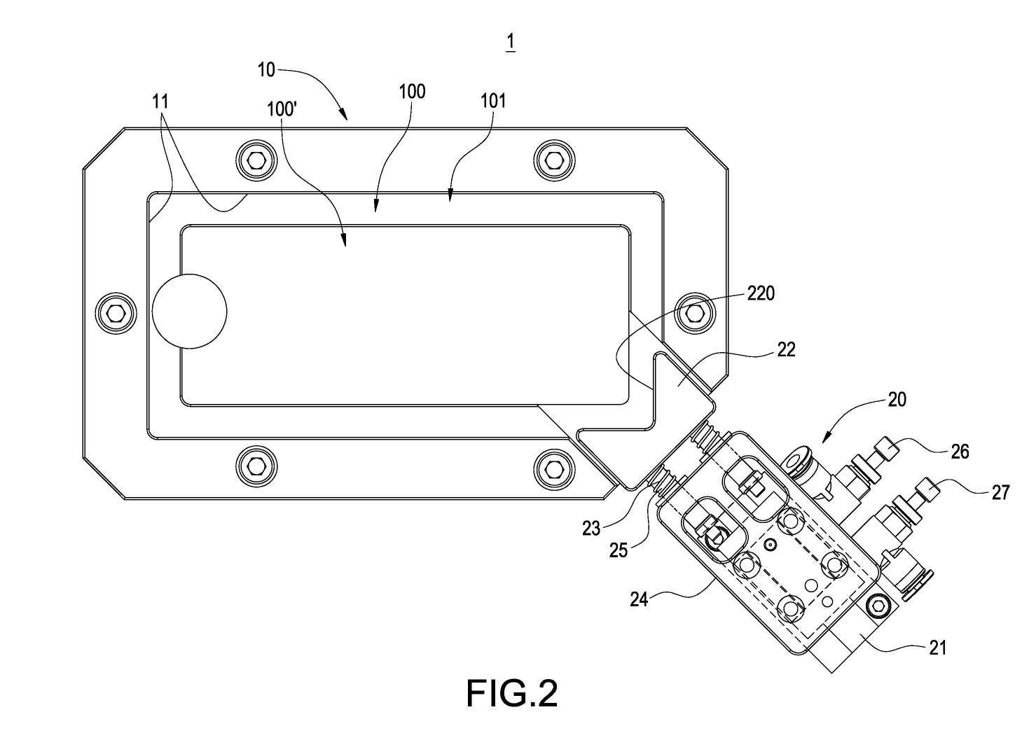

Please refer to FIG. 1 and FIG. 2, they depict a perspective schematic view and a plan schematic view of a fixture for clamping a workpiece according to the present invention. The present invention provides a fixture 1 for clamping a workpiece. The fixture 1 includes a supporting stand 10 and an elastic contacting assembly 20. The elastic contacting assembly 20 is disposed in a corner of the supporting stand 10 for providing a proper clamping force.

The supporting stand 10 has a first accommodating space 100 and a plural of fixing portions 11 formed in a periphery of the first accommodating space 100. The supporting stand 10 is a cuboid. The first accommodating space 100 is formed in a cuboid configuration, and one side of the supporting stand 10 is an opening 101. Preferably, the supporting stand 10 has a second accommodating space 100′ communicating with the first accommodating space 100. The first accommodating space 100 and the second accommodating space 100′ are arranged in stack, and the first accommodating space 100 is larger than the second accommodating space 100′. That is, the second accommodating space 100′ is situated in the bottom of the first accommodating space 100.

The elastic contacting assembly 20 includes a cylinder 21, a pushing block 22 driven by the cylinder 21 and moved toward the first accommodating space 100 and an elastic component 23 disposed between the cylinder 21 and the pushing block 22. In an embodiment of the present invention, the pushing block 22 has an L-shaped notch 220, and the L-shaped notch 220 is adjacent to the first accommodating space 100. In addition, the elastic component 23 could be embodied as a compressing spring.

Furthermore, the fixing portions 11 and the pushing block 22 are located on different sides of the first accommodating space 100. In the present embodiment, the fixing portions 11 can be embodied as, but not limited to, a plural of sidewalls formed on a periphery of the supporting stand 10. The fixing portions 11 can be provided as a plural of columns separately (not shown).

Moreover, the elastic contacting assembly 20 further includes a pushing set 24 and a pushing rod 25 inserted in the pushing set 24. The pushing block 22 connects the cylinder 21 through the pushing set 24 and the pushing rod 25, and the pushing rod 25 is sleeved with the elastic component 23. Besides, the cylinder 21 has an air inlet 26 and an air outlet 27. The locations of the air inlet 26 and the air outlet 27 are not limited as shown in the figures, and the locations of the air inlet 26 and the air outlet 27 could be exchanged. The operation of the elastic contacting assembly 20 will be described in more detail later.

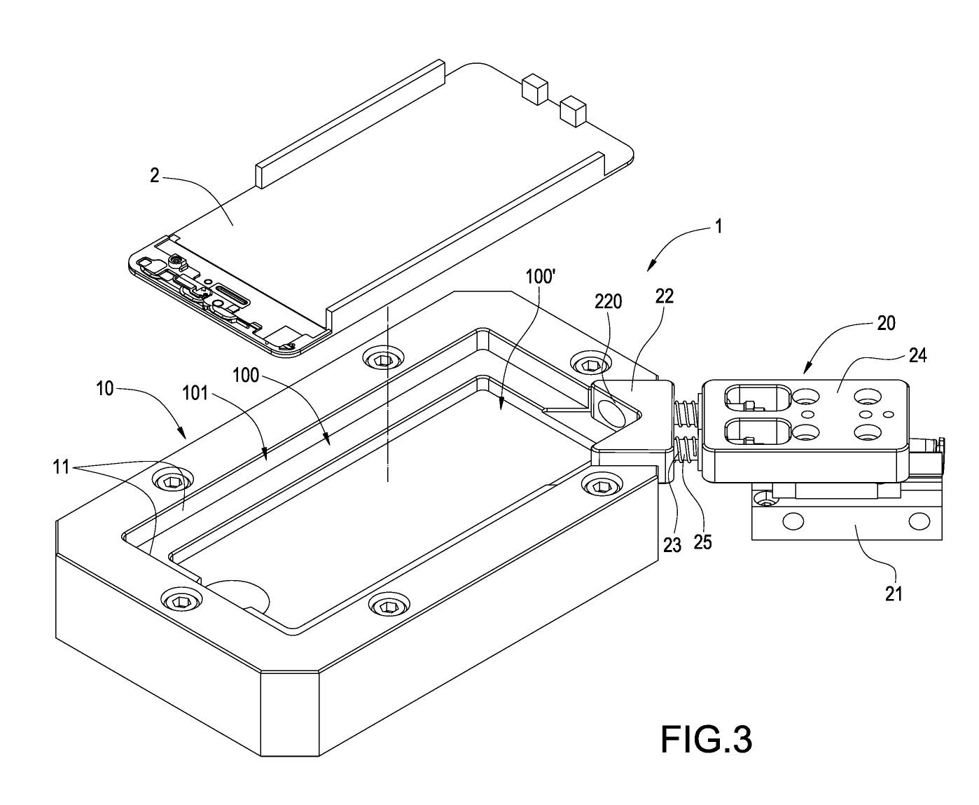

Please also refer to FIG. 3, it depicts a perspective view showing the application of a fixture according to the present invention. The fixture 1 of the present invention is applied for clamping a workpiece 2. The supporting stand 10 has the first accommodating space 100 for accommodating the workpiece 2, and the appearance of the workpiece 2 is corresponded to the shape of the first accommodating space 100.

It is worth notice that (if the bottom of the workpiece 2 is not formed in a plane but an incline or the bottom of the workpiece 2 is provided with components or the bottom of the workpiece 2 has protruding in the middle) the protruding portions can be accommodated in the second accommodating space 100′ when the workpiece 2 is disposed in the first accommodating space 100. Thus, the workpiece 2 will not be warped when being pushed by the pushing block 22.

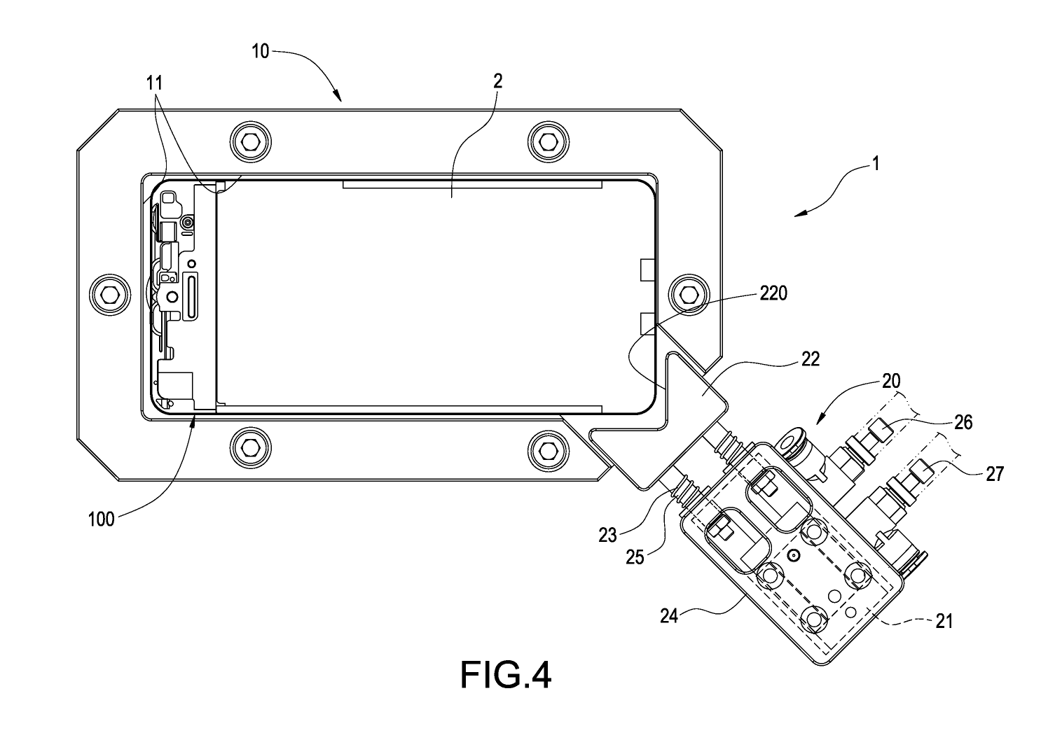

Please also refer to FIG. 4, it depicts a planar schematic view showing the application of a fixture according to the present invention. When the fixture 1 is used, the workpiece 2 will be disposed in the first accommodating space 100 from the opening 101 of the supporting stand 10. After the workpiece 2 disposing in the first accommodating space 100, the elastic contacting assembly 20 will start to operate. The workpiece 2 will be positioned in the supporting stand 10 by elastically clamping.

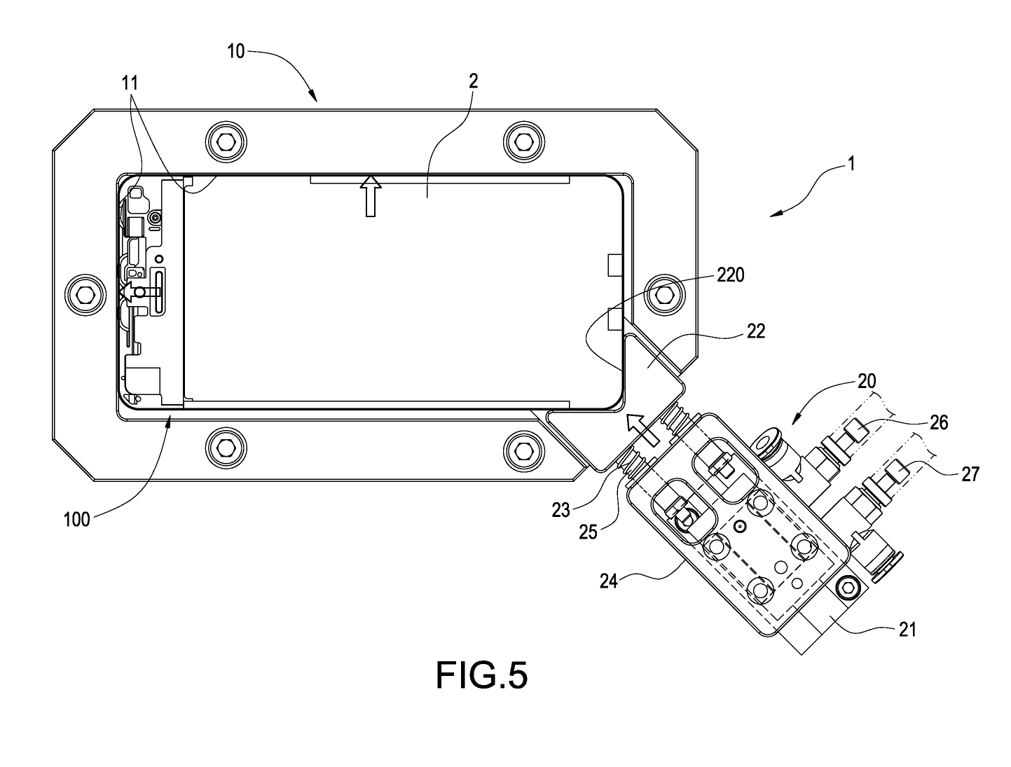

With referring to FIG. 5, it depicts a schematic view showing operation of a fixture according to the present invention. When the elastic contacting assembly 20 starts to operate, external gas enters the cylinder 21 from the gas inlet 26 and pushes the pushing set 24 to drive the push block 22 forward. In this moment, the elastic component 23 will be compressed by the push of the pushing set 24. On the contrary, when inner gas in the cylinder 21 is sent out from the gas outlet 27, the pushing set 24 and the pushing rod 25 will not be pushed by the gas, the elastic restoring force of the elastic element 23 will drive the pushing set 24 and the pushing rod 25 back to their original positions, and the pushing block 22 will go backward.

The pushing block 22 elastically pushes the workpiece 2 in the first accommodating space 100 through the elastic component 23; therefore, there will be no damage to the workpiece 2. Then the workpiece 2 will be positioned in the first accommodating space 100 of the supporting stand 10 by the elastic contacting assembly 20.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A fixture for clamping a workpiece, comprising:
a supporting stand, having a first accommodating space for accommodating the workpiece and a plural of fixing portions formed in a periphery of the first accommodating space; and
an elastic contacting assembly, disposed in a corner of the supporting stand, the elastic contacting assembly including a cylinder, a pushing block driven by the cylinder and moved toward the first accommodating space to lean against the workpiece, and an elastic component disposed between the cylinder and the pushing block.

2. The fixture according to claim 1, wherein the supporting stand is a cuboid, one side of the supporting stand is an opening, and the workpiece is disposed in the first accommodating space from the opening.

3. The fixture according to claim 2, wherein the supporting stand has a second accommodating space communicating with the first accommodating space, the first accommodating space and the second accommodating space are arranged in stack, and the first accommodating space is larger than the second accommodating space.

4. The fixture according to claim 3, wherein the second accommodating space is situated in the bottom of the first accommodating space.

5. The fixture according to claim 1, wherein the fixing portions and the pushing block are located on different sides of the first accommodating space.

6. The fixture according to claim 5, wherein the fixing portions are a plural of side walls formed on a periphery of the supporting stand.

7. The fixture according to claim 1, wherein the elastic contacting assembly further includes a pushing set and a pushing rod inserted in the pushing set, the pushing block connects the cylinder through the pushing set and the pushing rod, and the pushing rod is sleeved with the elastic component.

8. The fixture according to claim 7, wherein the cylinder has an air inlet and an air outlet.

9. The fixture according to claim 1, wherein the first accommodating space is formed in a cuboid configuration, the pushing block has an L-shaped notch, and the L-shaped notch is adjacent to the first accommodating space.

10. The fixture according to claim 1, wherein the elastic component is a compressing spring.
